(19) United States
(12) Patent Application Publication
(10) Pub. No.: US 2008/0083439 A1
(43) Pub. Date: Apr. 10, 2008

(54) Cleaning method and cleaner device for laminated substrate fabrication apparatus

(75) Inventors: Takanori Muramoto, Kasugai (JP); Tetsuji Kadowaki, Kasugai (JP); Yukio Takayama, Kasugai (JP); Ken Tsuboi, Kasugai (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kanagawa (JP)

(21) Appl. No.: 11/987,047

(22) Filed: Nov. 27, 2007

Related U.S. Application Data
(62) Division of application No. 11/248,164, filed on Oct. 13, 2005.

(30) Foreign Application Priority Data
Mar. 29, 2005 (JP) 2005-096164

(51) Int. Cl. B08B 3/12; B08B 5/00

(52) U.S. Cl. 134/117; 15/104.002

(57) ABSTRACT

A method for cleaning a laminated substrate fabrication apparatus that efficiently cleans a surface used to attract a substrate while enabling stable cleaning. A cleaning unit, which includes an attraction surface for attracting and holding the substrate, is arranged in a processing chamber to clean the attraction surface.

### CROSS-REFERENCE TO RELATED APPLICATIONS

This application is based upon and claims the benefit of priority from prior Japanese Patent Application No. 2005-096164, filed on Mar. 29, 2005, the entire contents of which are incorporated herein by reference.

This is a divisional of application Ser. No. 11/248,164, filed Oct. 13, 2005.

### BACKGROUND OF THE INVENTION

The present invention relates to a method and a device for cleaning a laminated substrate fabrication apparatus for fabricating a panel, such as a liquid crystal display (LCD) in which two substrates are laminated.

In recent years, there is a demand for larger and more inexpensive planar display panels, such as an LCD. As a result, there is a demand for a larger and more productive laminated substrate fabrication apparatus that laminates two substrates.

A laminated substrate fabrication apparatus includes two chucks for holding an upper substrate and a lower substrate in a processing chamber. The chucks may be vacuum chucks and/or electrostatic chucks that attract the upper substrate and the lower substrate. The processing chamber is evacuated in a state in which the upper and lower substrates are respectively attracted to the two chucks. The two substrates are then pressed and laminated with each other in the evacuated chamber.

In the laminated substrate fabrication apparatus, foreign substances, such as dusts that adhere on the attraction surface of the chuck, lowers the attraction performance of the chuck. As a result, a substrate may fall off a chuck and lamination accuracy may be lowered during the fabrication of a laminated substrate.

Therefore, in the prior art, an operator removes a chuck from the laminated substrate fabrication apparatus to clean the chuck outside the processing chamber on a regular basis. Further, when cleaning a large chuck, the operator manually cleans the attraction surface in the processing chamber without removing the chuck from the laminated substrate fabrication apparatus.

Japanese Laid-Open Patent Publication No. 2002-1239 describes a method for cleaning a reticle. Japanese Laid-Open Patent Publication No. 2002-231699 describes a method for cleaning a silicon electrode used to generate fluorocarbon plasma. Japanese Laid-Open Patent Publication No. 2002-361190 describes a method for cleaning a pass box and a recording head.

### SUMMARY OF THE INVENTION

In the above method in which the operator removes the chuck from the laminated substrate fabrication apparatus to clean the chuck outside the processing chamber on a regular basis, time is required to remove the chuck from the apparatus, attach the chuck to the apparatus after cleaning the chuck, and adjust the attachment position of the chuck. This lowers productivity. Further, in the conventional method, space for removing and cleaning the chuck is also necessary.

With the conventional method in which the chuck is cleaned without removing it from the laminated substrate fabrication apparatus, the time required to remove and attach the chuck are not necessary and space for performing such operations is not required. However, since the cleaning is performed manually, the chuck is not always cleaned in the same manner.

The present invention provides a method and a device for efficiently cleaning the attraction surface of the laminated substrate fabrication apparatus so that the attraction surface is always cleaned in the same manner.

One aspect of the present invention is a method for cleaning an attraction surface of a laminated substrate fabrication apparatus in a processing chamber. The laminated substrate fabrication apparatus laminates a plurality of substrates and includes the attraction surface for attracting and holding one of the substrates in the processing chamber. The method includes the steps of arranging a cleaning unit in the processing chamber, and cleaning the attraction surface with the cleaning unit in the processing chamber.

Another aspect of the present invention is a cleaning unit for cleaning an attraction surface of a laminated substrate fabrication apparatus in a processing chamber. The laminated substrate fabrication apparatus laminates a plurality of substrates in the processing chamber and includes the processing chamber and the attraction surface for attracting and holding one of the substrates in the processing chamber. The cleaning unit includes a cleaning component for cleaning the attraction surface in the processing chamber, and a mechanism for arranging the cleaning component in the processing chamber.

A further aspect of the present invention is a cleaner device for cleaning an attraction surface of a laminated substrate fabrication apparatus, which laminates a plurality of substrates in a processing chamber. The laminated substrate fabrication apparatus including the processing chamber and the attraction surface for attracting and holding one of the substrates in the processing chamber. The cleaner device includes a guide mechanism arranged on the laminated substrate fabrication apparatus. A cleaning unit is placed in the processing chamber and cleans the attraction surface in the processing chamber. The cleaning unit is movable along the guide mechanism.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiment together with the accompanying drawings in which:

FIGS. 1 to 8 are schematic cross-sectional views respectively showing cleaner devices according to first to eighth embodiments of the present invention.

### DETAILED DESCRIPTION OF THE PREFERRED EMBODIMENTS

### First Embodiment

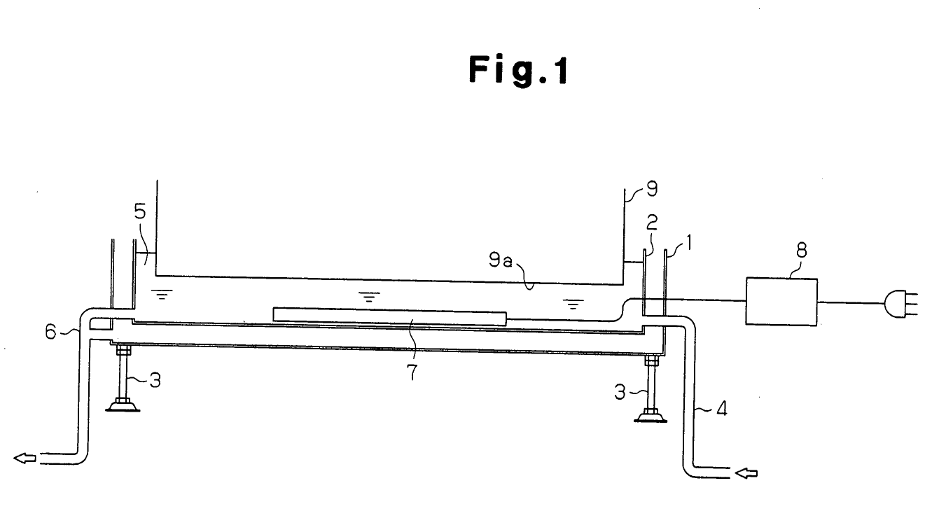

FIG. 1 shows a cleaner device according to a first embodiment of the present invention. The cleaner device is arranged inside a processing chamber to clean an upper chuck (electrostatic chuck), which holds an upper substrate.

The cleaner device includes an outer container 1, an inner container 2, and an ultrasonic oscillator 7. The inner container 2 is arranged inside the outer container 1. The inner container 2 is spaced from the outer container 1 by a predetermined distance. An example of the outer container 1 and the inner container 2 is a box having an open top. An assembly of the outer and inner containers 1, 2 and the ultrasonic oscillator 7 serves as a cleaning unit. The outer and inner containers 1, 2 and the ultrasonic oscillator 7 serve as a cleaning component.

A plurality of support legs 3 extend from the bottom surface of the outer container 1. The support legs 3 support the outer container 1 in the processing chamber of the laminated substrate fabrication apparatus. Each support leg 3 is telescopic. The location of the outer container 1, or the height of the outer container 1 from the floor of the processing chamber, may be adjusted by changing the lengths of the support legs 3. The support legs 3 serve as a mechanism for arranging the cleaning component in the processing chamber.

A supply pipe 4 and a drain pipe 6, which lead to the outside of the outer container 1, are connected to the inner container 2. Cleaning liquid 5 is supplied to the inner container 2 through the supply pipe 4 and is stored in the inner container 2. The cleaning liquid 5 that overflows from the inner container 2 is received by the outer container 1. The drain pipe 6 is connected to the outer container 1 and the inner container 2. The drain pipe 6 is used to discharge the cleaning liquid 5 from the outer container 1 and the inner container 2.

The ultrasonic oscillator 7 is arranged inside the inner container 2. An ultrasonic oscillator driver 8 is arranged outside the outer container 1. The ultrasonic oscillator driver 8 drives the ultrasonic oscillator 7 to ultrasonically vibrate the cleaning liquid 5 stored in the inner container 2.

A method for cleaning the upper chuck 9 with the cleaner device will now be explained.

First, the cleaner device is transferred into the processing chamber through a load port, through which substrates enter the processing chamber of the laminated substrate fabrication apparatus, or a maintenance port, through which maintenance work is performed on the laminated substrate fabrication apparatus. Then, the lengths of the support legs 3 and the height and levelness of the cleaner device are adjusted to position the attraction surface 9a of the upper chuck 9 in the inner container 2.

Next, the cleaning liquid 5 is supplied to the inner container 2, and the entire attraction surface 9a of the upper chuck 9 is immersed in the cleaning liquid 5. The cleaning liquid 5 is, for example, pure water.

The ultrasonic oscillator 7 is then driven and the attraction surface 9a of the upper chuck 9 is ultrasonically cleaned with the cleaning liquid 5.

While the ultrasonic oscillator 7 is being driven, the cleaning liquid 5 is continuously supplied to the inner container 2 from the supply pipe 4. Thus, the cleaning liquid 5 overflows from the inner container 2. Foreign materials such as dust removed from the attraction surface 9a are discharged from the drain pipe 6 with the overflowing cleaning liquid 5.

After the cleaning of the attraction surface 9a is completed, all of the cleaning liquid 5 is discharged from the inner container 2. The cleaner device is then transferred out of the processing chamber. Moisture is then removed from the attraction surface 9a with a cleaning towel wetted with pure water. The attraction surface 9a is then wiped with a volatile solvent, such as acetone. This substantially removes all moisture from the attraction surface 9a. The processing chamber is then sealed, and the processing chamber is evacuated to completely discharge the cleaning atmosphere.

The cleaning method and the cleaner device of the first embodiment have the advantages described below.

(1) The cleaner device is installed inside the processing chamber to clean the attraction surface 9a of the upper chuck 9 in the processing chamber. Therefore, the upper chuck 9 does not need to be moved out of the processing chamber of the laminated substrate fabrication apparatus for cleaning.

(2) The entire surface of the attraction surface 9a is immersed in the cleaning liquid 5 and cleaned in the inner container 2. Therefore, the attraction surface 9a of the upper chuck 9 is uniformly and quickly cleaned.

(3) The ultrasonic cleaning efficiently cleans the attraction surface 9a.

(4) Cleaning is performed as the cleaning liquid 5 overflows from the inner container 2. This prevents foreign substances removed from the attraction surface 9a from adhering again on the attraction surface 9a.

### Second Embodiment

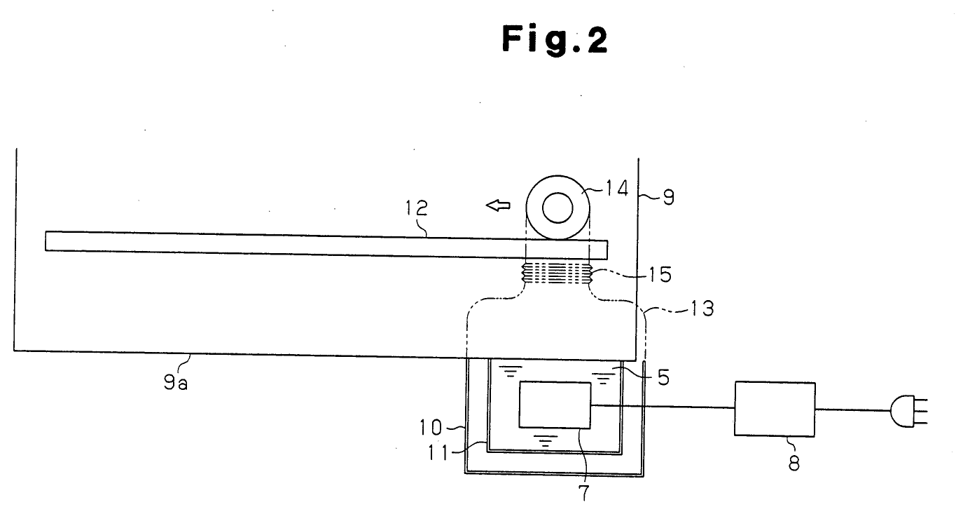

FIG. 2 shows a cleaner device according to a second embodiment of the present invention. The cleaner device includes a cleaning unit for cleaning the attraction surface 9a while moving along the attraction surface 9a of the upper chuck 9, and a guide mechanism for guiding the movement of the cleaning unit.

The cleaning unit includes an outer container 10, an inner container 11, and an ultrasonic oscillator 7. The inner container 11 is arranged inside the outer container 10. A supply pipe (not shown) for supplying the cleaning liquid 5 is connected to the inner container 11. A drain pipe (not shown) is connected to the outer container 10 and the inner container 11. The ultrasonic oscillator 7 is arranged in the inner container 2. The ultrasonic oscillator 7 is driven by the ultrasonic oscillator driver 8.

The width (dimension in the direction orthogonal to the movement direction of the cleaning unit) of the outer container 10 and the inner container 11 corresponds to the width (dimension in the direction orthogonal to the plane of FIG. 2) of the attraction surface 9a. In other words, the length of one side of the outer container 10 and the inner container 11 is equal to or longer than the length of a corresponding side of the attraction surface 9a.

An example of the guide mechanism is a guide rail 12 extending horizontally relative to the external surface (e.g., external surface of the processing chamber) of the laminated substrate fabrication apparatus. The guide rail 12 may be formed along each side surface of the upper chuck 9.

A support arm 13 arranged outside the processing chamber is formed on each of two opposite sides of the outer container 10. A roller 14 is rotatably attached to each support arm 13. The roller 14 rolls along one of the guide rails 12.

When the roller 24 rolls along the guide rail 12, the outer container 10 moves along the attraction surface 9a of the upper chuck 9. The cleaning liquid 5 that overflows from the inner container 11 cleans the attraction surface 9a.

An adjuster 15 for adjusting the distance between the outer container 10 and the attraction surface 9a is arranged between the support arms 13.

The outer and inner containers 10, 11 and the ultrasonic oscillator 7 serve as a cleaning component. The support arm 13 and the adjuster 15 serve as a mechanism for arranging the cleaning component in the processing chamber.

In addition to the advantages (1), (3), (4) of the first embodiment, the cleaning method and the cleaner device of the second embodiment have the advantages described below.

(1) The cleaning unit moves along the attraction surface 9a of the upper chuck 9. This enables the relatively large attraction surface 9a to be cleaned. The cleaning unit is inexpensive since the outer container 10 and the inner container 11 are relatively small. Further, the attraction surface 9a is cleaned with a relatively small amount of the cleaning liquid 5. This reduces the cleaning cost.

### Third Embodiment

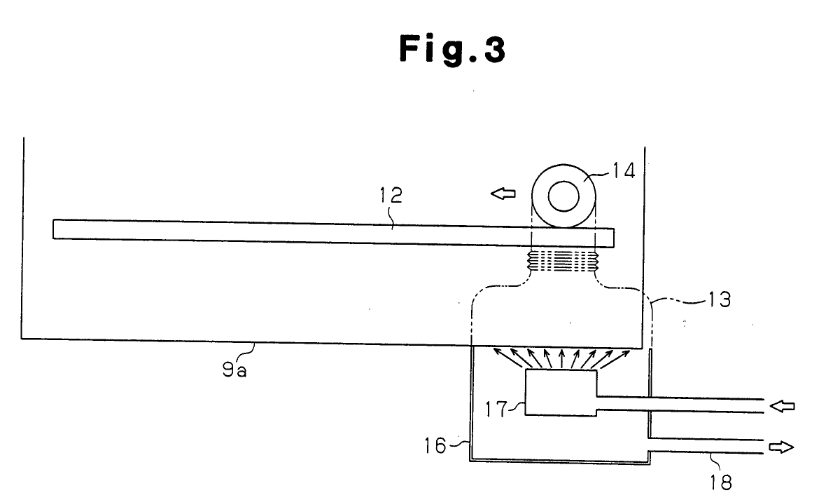

FIG. 3 shows a cleaner device according to a third embodiment of the present invention. The third embodiment differs from the second embodiment in that the cleaner device uses gas as a cleaning medium.

A blower 17 (gas ejector) including an ultrasonic oscillator is arranged in the outer container 16 of the cleaning unit. The cleaning gas is pressurized to a predetermined pressure, which is greater than or equal to the atmospheric pressure, and supplied to the blower 17 from outside the outer container 16. The blower 17 upwardly ejects the cleaning gas. An example of the cleaning gas is clean air, which is filtered to remove dust and the like.

An exhaust pipe 18 is connected to the outer container 16. The air ejected from the blower 17 is discharged through the exhaust pipe 18. The distal end of the exhaust pipe 18 may be connected to a suction pump or may just be left open.

The outer container 16 includes the support arms 13 and the rollers 14. When the rollers 14 roll along the guide rails 12, the outer container 16 moves along the attraction surface 9a.

Air is ejected toward the attraction surface 9a from the blower 17 in the outer container 16 as the cleaning unit moves along the attraction surface 9a. This cleans the attraction surface 9a with air. The outer container 16 prevents foreign substances removed from the attraction surface 9a from being diffused and adhering again on a different location of the attraction surface 9a. The third embodiment has the same advantages as the second embodiment.

The cleaning medium is gas. Thus, the cleaning unit may be reversed. That is, the opening of the outer container 16 may face downward so that gas is downwardly ejected from the blower 17. In this case, the cleaning unit is supported so as to be movable along the attraction surface of a lower chuck, which holds a lower substrate. Gas is ejected downward from the blower 17 as the cleaning unit moves along the attraction surface of the lower chuck. The outer container 16 and the blower 17 serve as a cleaning component. The support arm 13 serves as a mechanism for arranging the cleaning component in the processing chamber.

### Fourth Embodiment

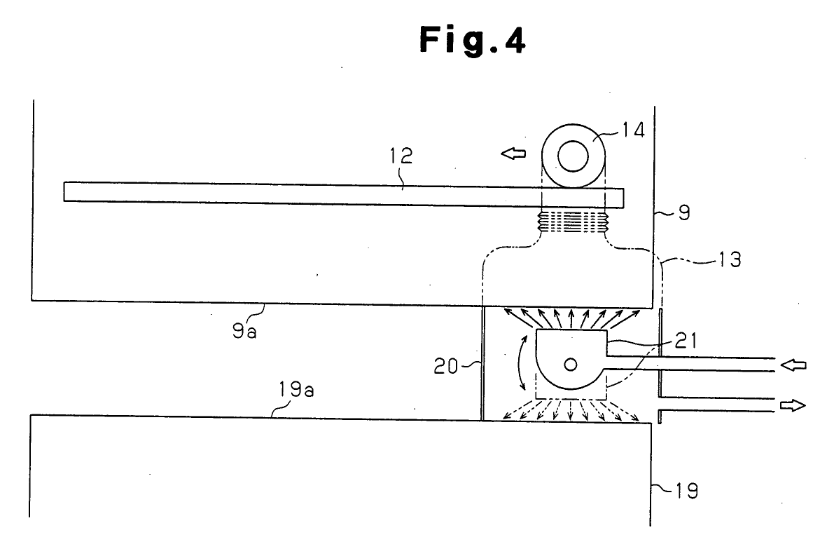

FIG. 4 shows a cleaner device according to a fourth embodiment of the third embodiment. In the same manner as the third embodiment, the cleaner device of the fourth embodiment includes a cleaning unit that is movable along guide rails 12, which function as a guide mechanism. The outer container 20 of the cleaning unit has an open top and bottom. A blower 21 (gas ejector) is arranged in the outer container 20. The blower 21 includes an ejection surface. The blower 21 is rotatable so that the ejection surface faces upward or downward. Due to such rotation, the cleaner device selectively cleans an attraction surface 9a of an upper chuck 9 and an attraction surface 19a of a lower chuck 19, which holds the lower substrate. The remaining structure is the same as the third embodiment. The outer container 20 and the blower 21 serve as a cleaning component. The support arm 13 serves as a mechanism for arranging the cleaning component in the processing chamber.

In addition to the advantages of the third embodiment, the fourth embodiment has an advantage in that the attraction surface 9a of the upper chuck 9 and the attraction surface 19a of the lower chuck 19 are cleaned with the same cleaning unit. Since separate cleaning units do not have to be prepared to clean each of the attraction surfaces 9a and 19a, the cleaning unit of the fourth embodiment is inexpensive and the cleaning cost is reduced.

### Fifth Embodiment

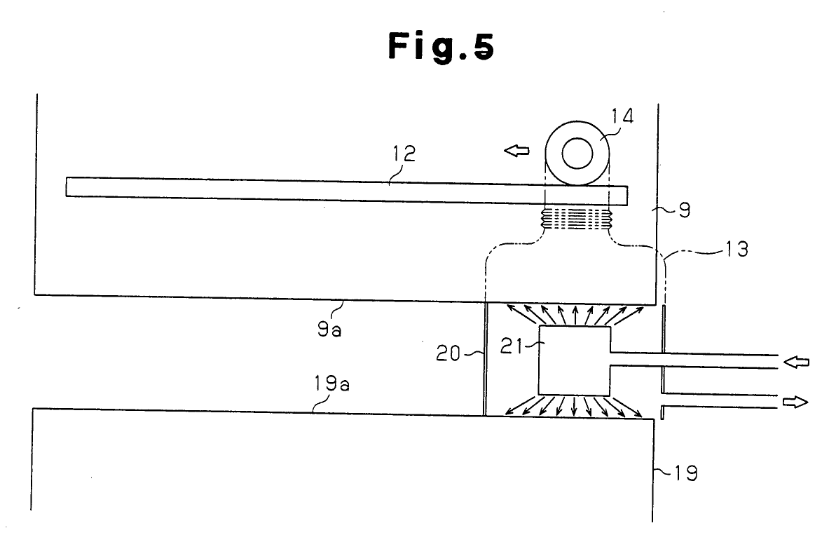

FIG. 5 shows a cleaner device according to a fifth embodiment of the present invention. The cleaner device of the fifth embodiment differs from the fourth embodiment in that the blower 21 in the outer container 20 ejects air in both upward and downward directions. The remaining structure is the same as the fourth embodiment.

The blower 21 simultaneously ejects air towards the attraction surfaces 9a and 19a. Thus, the cleaner device simultaneously cleans the attraction surfaces 9a and 19a. This shortens the cleaning time and reduces the cleaning cost. The outer container 20 and the blower 21 each serve as a cleaning component. The support arm 13 serves as a mechanism for arranging the cleaning component in the processing chamber.

### Sixth Embodiment

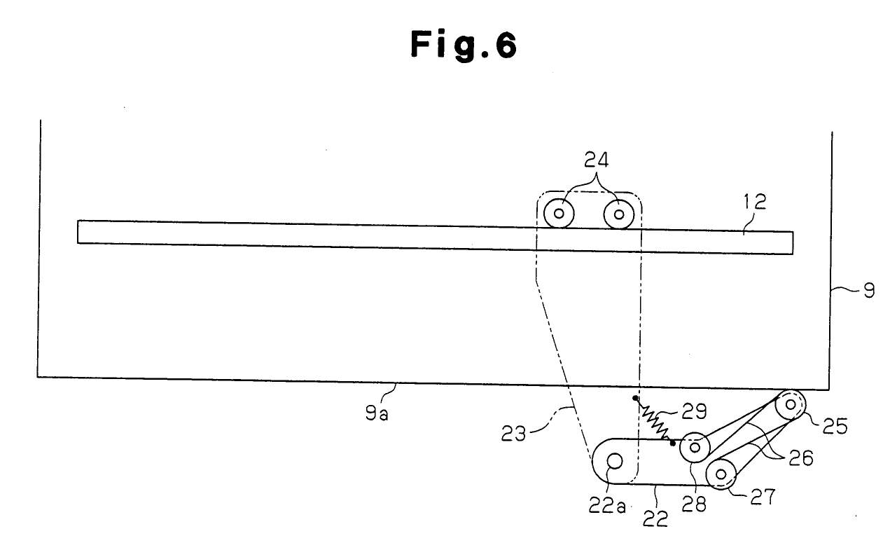

FIG. 6 shows a cleaner device according to a sixth embodiment of the present invention. The cleaner device includes a cleaning unit that uses adhesive tape as a cleaning medium. The cleaning unit includes two support arms 23 (only one is shown in FIG. 6), each provided with rollers 24, and two levers 22 (only one is shown in FIG. 6), each supported by one of the two support arms 23. The two levers 22 are each arranged on opposite sides of the attraction surface 9a in the lateral direction (direction orthogonal to the plane of FIG. 6). A pivot shaft 22a enables each lever 22 to pivot with respect to the corresponding support arms 23. When the rollers 24 roll along the guide rail 12, the lever 22 moves along the attraction surface 9a.

A pressing roller 25 extends between the distal ends of the two levers 22. The two levers 22 support the pressing roller 25 rotatably and parallel to the attraction surface 9a. A feed roller 27, which feeds out adhesive tape 26, and a wind roller 28, which winds the adhesive tape 26, extend between the basal ends of the two levers 22. When the pressing roller 25 is rotated, the adhesive tape 26 is fed from the feed roller 27 to the pressing roller 25 and then wound around the wind roller 28.

A coil spring 29 is arranged between the lever 22 and the support arm 23. The pressing roller 25 is pressed towards the attraction surface 9a by the biasing force of the coil spring 29. That is, the coil spring 29 has a biasing force acting to reduce the angle between the lever 22 and the support arm 23.

When the levers 22 move along the attraction surface 9a, the pressing roller 25 rolls and presses the attraction surface 9a.

When the pressing roller 25 rolls, the adhesive tape 26 is fed from the feed roller 27 to the pressing roller 25 and wound about the wind roller 28. The adhesive tape 26 has an adhesive side pressed against the attraction surface 9a by the pressing roller 25. Movement of the cleaning unit along the guide rail 12 sequentially removes foreign substances from the attraction surface 9a with the adhesive side of the adhesive tape 26.

The pressing roller 25 is pressed against the attraction surface 9a by the biasing force of the coil spring 29. This ensures that the attraction surface 9a is cleaned without having to accurately adjust the distance between the attraction surface 9a and the lever 22. The cleaning of the attraction surface 9a is performed just by attaching the cleaning unit to the guide rail 12. This facilitates cleaning preparations. The components 22, 25, 26, 27, 28, and 29 each serve as a cleaning component. The support arm 23 serves as a mechanism for arranging the cleaning component in the processing chamber.

### Seventh Embodiment

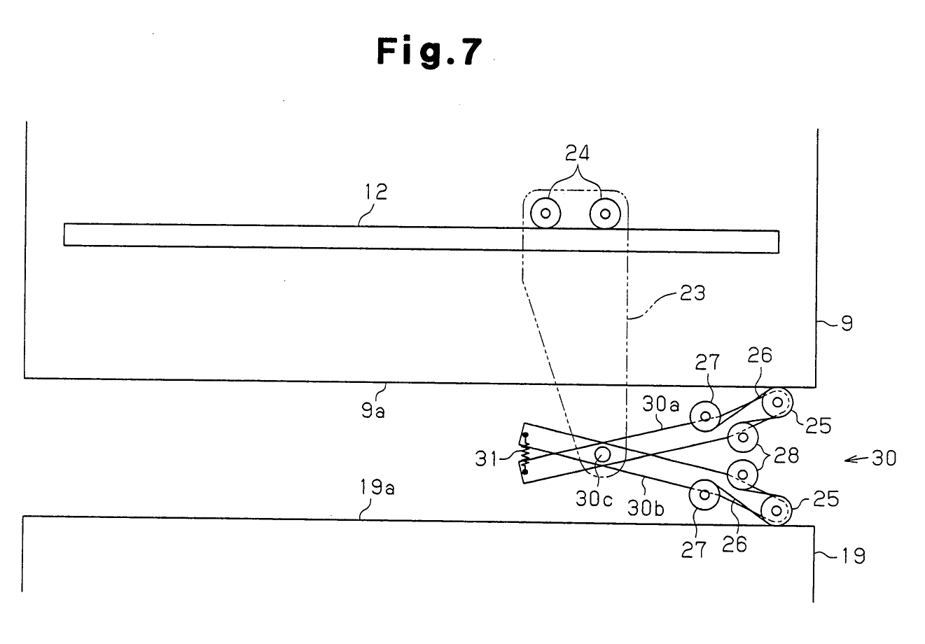

FIG. 7 shows a cleaner device according to a seventh embodiment of the present invention. The cleaner device includes a cleaning unit for simultaneously cleaning the attraction surfaces 9a and 19a of the upper chuck 9 and the lower chuck 19 with adhesive tape.

The cleaning unit includes two support arms 23 (only one is shown in FIG. 7), each provided with rollers 24, and two lever assemblies 30 (only one is shown in FIG. 7), each supported by one of the two support arms 23. The lever assemblies 30 are each arranged on opposite sides of the attraction surface 9a in the lateral direction (direction orthogonal to the plane of FIG. 7).

Each lever assembly 30 includes two levers 30a and 30b, a pivot shaft 30c, and a coil spring 31. The pivot shaft 30c enables the levers 30a and 30b to pivot with respect to the corresponding support arm 23.

When the rollers 24 roll along the guide rail 12, the levers 30a and 30b move along the attraction surface 9a. A pressing roller 25, a feed roller 27, and a wind roller 28 are attached to each of the levers 30a and 30b. The adhesive tape 26 is fed from the feed roller 27 to the pressing roller 25 and then wound about the wind roller 28.

The coil spring 31 connects the basal ends of the levers 30a and 30b. The coil spring 31 biases the basal ends of the levers 30a and 30b away from each other. Thus, the biasing force of the coil spring 31 presses the pressing roller 25 of the levers 30a against the attraction surface 9a and the pressing roller 25 of the lever 30b against the attraction surface 19a.

When the support arms 23 move along the guide rails 12, the two pressing rollers 25 roll and press the attraction surfaces 9a and 19a.

In addition to the advantages of the sixth embodiment, the seventh embodiment has an advantage in which the attraction surfaces 9a and 19a are simultaneously cleaned.

### Eighth Embodiment

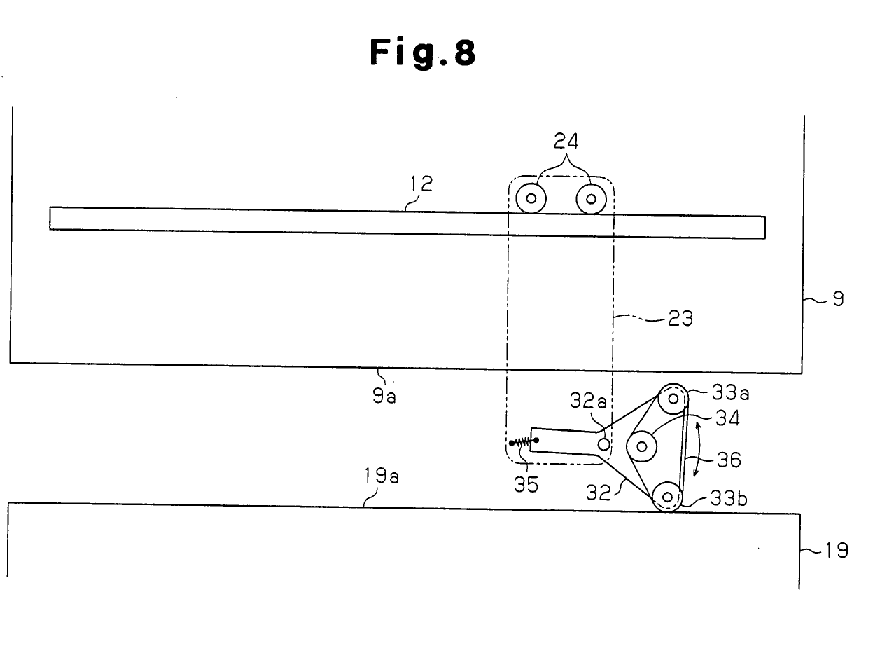

FIG. 8 shows a cleaner device according to an eighth embodiment of the present invention. The cleaner device includes a cleaning unit for cleaning the attraction surfaces 9a and 19a of the upper chuck 9 and the lower chuck 19 with the same adhesive tape.

The cleaning unit includes two support arms 23 (only one is shown in FIG. 8), each provided with rollers 24, and two levers 32 (only one is shown in FIG. 8), each supported by one of the two support arms 23. The two levers 32 are each arranged on opposite sides of the attraction surface 9a in the lateral direction (direction orthogonal to the plane of FIG. 8). A pivot shaft 32a enables the lever 32 to pivot with respect to the support arm 23.

Pressing rollers 33a and 33b and a guide roller 34 are arranged on each lever 32. An endless adhesive tape 36 is wound around the pressing roller 33a and 33b and the guide roller 34.

A biasing device 35 connects the basal ends of the lever 32 and the support arm 23. The biasing device 35 switches between an operation for pushing the lever 32 and an operation for pulling the lever 32 using the support arm 23 as a fulcrum. An example of the biasing device 35 is a telescopic linear actuator.

When the biasing device 35 pushes the lever 32, the pressing roller 33b is pressed against the attraction surface 19a of the lower chuck 19. When the biasing device 35 pulls the lever 32, the pressing roller 33a is pressed against the attraction surface 9a of the upper chuck 9.

The lever 32 moves along the guide rails 12 with the pressing roller 33a pressed against the attraction surface 9a so that the adhesive tape 36, which is pressed against the pressing roller 33a, sequentially cleans the attraction surface 9a.

The lever 32 moves along the guide rails 12 with the pressing roller 33b pressed against the attraction surface 19a so that the adhesive tape 36, which is pressed against the pressing roller 33b, sequentially cleans the attraction surface 19a.

In addition to the advantages of the sixth embodiment, the eighth embodiment has an advantage in which the cleaning unit cleans the attraction surfaces 9a and 19a with the same adhesive tape 36. This reduces the cleaning cost.

The lever assembly 30 serves as a cleaning component. The support arm 23 serves as a mechanism for arranging the cleaning component in the processing chamber.

It should be apparent to those skilled in the art that the present invention may be embodied in many other specific forms without departing from the spirit or scope of the invention. Particularly, it should be understood that the present invention may be embodied in the following forms.

The cleaning liquid 5 discharged from the drain pipe 6 may be filtered before being returned to the inner container 2. By circulating the cleaning liquid 5 in this manner, the total amount of the cleaning liquid 5 that is used may be reduced.

It should be apparent to those skilled in the art that the present invention may be embodied in many other specific forms without departing from the spirit or scope of the invention. Therefore, the present invention is not to be limited to the details given herein, but may be modified within the scope and equivalence of the appended claims.

What is claimed is:

1. A cleaning unit for cleaning an attraction surface of a laminated substrate fabrication apparatus in a processing chamber, wherein the laminated substrate fabrication apparatus laminates a plurality of substrates in the processing chamber and includes the processing chamber and the attraction surface for attracting and holding one of the substrates in the processing chamber, the cleaning unit comprising:
a cleaning component for cleaning the attraction surface in the processing chamber; and
a mechanism for arranging the cleaning component in the processing chamber.

2. The cleaning unit according to claim 1, wherein the cleaning component includes:
a container for storing cleaning liquid and for contacting the cleaning liquid with the attraction surface in the processing chamber; and
an ultrasonic oscillator, arranged in the inner container, for ultrasonically vibrating the cleaning liquid.

3. The cleaning unit according to claim 1, wherein the mechanism for arranging the cleaning component in the processing chamber is provided with a function for adjusting the height of the cleaning component in the processing chamber.

4. The cleaning unit according to claim 1, wherein the cleaning unit is configured to move along the attraction surface and is for use with a cleaning liquid, and wherein the cleaning unit is operable for bringing the cleaning liquid into contact with the attraction surface while the cleaning liquid is ultrasonically vibrated.

5. The cleaning unit according to claim 1, wherein the cleaning unit is configured to move along the attraction surface and is for use with a cleaning gas, and wherein the cleaning unit ejects the cleaning gas toward the attraction surface while the cleaning gas is ultrasonically vibrated.

6. The cleaning unit according to claim 1, wherein the cleaning unit is configured to move along the attraction surface and is for use with an adhesive tape, and wherein the cleaning unit presses the adhesive tape against the attraction surface.

7. A cleaner device for cleaning an attraction surface of a laminated substrate fabrication apparatus, which laminates a plurality of substrates in a processing chamber, the laminated substrate fabrication apparatus including the processing chamber and the attraction surface for attracting and holding one of the substrates in the processing chamber, the cleaner device comprising:
a guide mechanism arranged on the laminated substrate fabrication apparatus; and
a cleaning unit to be placed in the processing chamber and for cleaning the attraction surface in the processing chamber, the cleaning unit being movable along the guide mechanism.
